(19) United States
(12) Patent Application Publication
(10) Pub. No.: US 2010/0127420 A1
(43) Pub. Date: May 27, 2010

(54) METHOD OF FORMING A SHAPED ARTICLE FROM A SHEET OF MATERIAL

(76) Inventor: Thierry Luc Alain Dannoux, Avon (FR)

Correspondence Address: CORNING INCORPORATED, SP-TI-3-1, CORNING, NY, 14831, US

(21) Appl. No.: 12/277,528

(22) Filed: Nov. 25, 2008

(51) Int. Cl. B29C 43/04; B29C 43/42

(52) U.S. Cl. 264/235; 425/330; 264/322; 264/318; 264/232

(57) ABSTRACT

An apparatus for forming a shaped article having a first surface with a first surface profile and a second surface with a second surface profile is provided. The apparatus includes a first end mold having a cavity formed therein, where the cavity is defined by a surface having at least a portion of the first surface profile. The apparatus includes an intermediate mold having a hole formed therein. The intermediate mold is distinct from the first end mold and is configured for stacking against the first end mold such that the hole is aligned with the cavity. The apparatus includes a second end mold having a protuberance formed on a surface thereof. The protuberance is defined by a surface having at least a portion of the second surface profile and is sized for insertion into the hole and cavity.

### FIELD

The invention relates generally to methods and apparatus for forming shaped articles. More specifically, the invention relates to a method and an apparatus for reforming a thin sheet of material into a shaped article.

### BACKGROUND

Molding is a common technique used to make shaped objects. Precision molding is suitable for forming shaped glass articles, particularly when the final glass article is required to have a high dimensional accuracy and a high-quality surface finish. In precision molding, a glass preform having an overall geometry similar to that of the final glass article is pressed between a pair of mold surfaces to form the final glass article. The process requires high accuracy in delivery of the glass preform to the molds as well as precision ground and polished mold surfaces and is therefore expensive.

Press molding based on pressing a gob of molten glass into a desired shape with a plunger can be used to produce shaped glass articles at a relatively low cost, but generally not to the high tolerance and optical quality achievable with precision molding. Where the molten glass has to be spread thinly to make a thin-walled glass article having complex curvatures, the molten glass may become cold, or form a cold skin, before reaching the final desired shape. Shaped glass articles formed from press molding a gob of molten glass may exhibit one or more of shear marking, warping, optical distortion due to low surface quality, and overall low dimensional precision.

### SUMMARY

In one aspect, the invention relates to an apparatus for forming a shaped article having a first surface with a first surface profile and a second surface with a second surface profile. The apparatus comprises a first end mold having a cavity formed therein. The cavity is defined by a surface having at least a portion of the first surface profile. The apparatus further includes an intermediate mold having a hole formed therein. The intermediate mold is distinct from the first end mold and is configured for stacking against the first end mold such that the hole is aligned with the cavity. The apparatus includes a second end mold having a protuberance formed on a surface thereof. The protuberance is defined by a surface having at least a portion of the second surface profile and is sized for insertion into the hole and cavity.

In another aspect, the invention relates to an apparatus for forming a plurality of shaped articles, wherein each shaped article has a first surface with a surface profile and a second surface with a second surface profile. The apparatus comprises a first end mold having a plurality of cavities formed therein. Each of the cavities is defined by a surface having at least a portion of the first surface profile. The apparatus includes an intermediate mold having a plurality of holes formed therein. The intermediate mold is distinct from the first end mold and is configured for stacking against the first end mold such that each of the holes is aligned with one of the cavities. The apparatus includes a second end mold having a plurality of protuberances formed on a surface thereof. Each of the protuberances is defined by a surface having at least a portion of the second surface profile and is sized for insertion into one of the holes and one of the cavities.

In yet another aspect, the invention relates to a method of making a shaped article having a first surface with a first surface profile and a second surface with a second surface profile. The method comprises aligning a cavity in a first end mold with a protuberance in a second end mold. The cavity is defined by a surface having at least a portion of the first surface profile. The protuberance is defined by a surface having at least a portion of the second surface profile. The method includes placing a sheet of glass-based material at a bottom of the cavity. The method further includes compressing the sheet between the surface having at least a portion of the first surface profile and the surface having at least a portion of the second surface profile to impress at least a portion of the first surface profile and at least a portion of the second surface profile on a first surface and a second surface, respectively, of the sheet, thereby forming a shaped article.

Other features and advantages of the invention will be apparent from the following description and the appended claims.

### BRIEF DESCRIPTION OF DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain views of the figures may be shown exaggerated in scale or in schematic in the interest of clarity and conciseness.

FIG. 1 is a cross-sectional view of an apparatus for making a shaped article.

FIG. 2 is a cross-sectional view of an apparatus for making a plurality of shaped articles.

FIG. 3 shows a sheet of material disposed in a bottom of a cavity in a mold.

FIG. 4 shows a protuberance inserted into a cavity of a mold containing a sheet of material.

FIG. 5 shows a sheet of material compressed between a protuberance and a cavity of a mold.

FIG. 6 shows apparatus stacked for making multiple shaped articles.

### DETAILED DESCRIPTION

The invention will now be described in detail with reference to a few embodiments, as illustrated in the accompanying drawings. In describing the embodiments, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

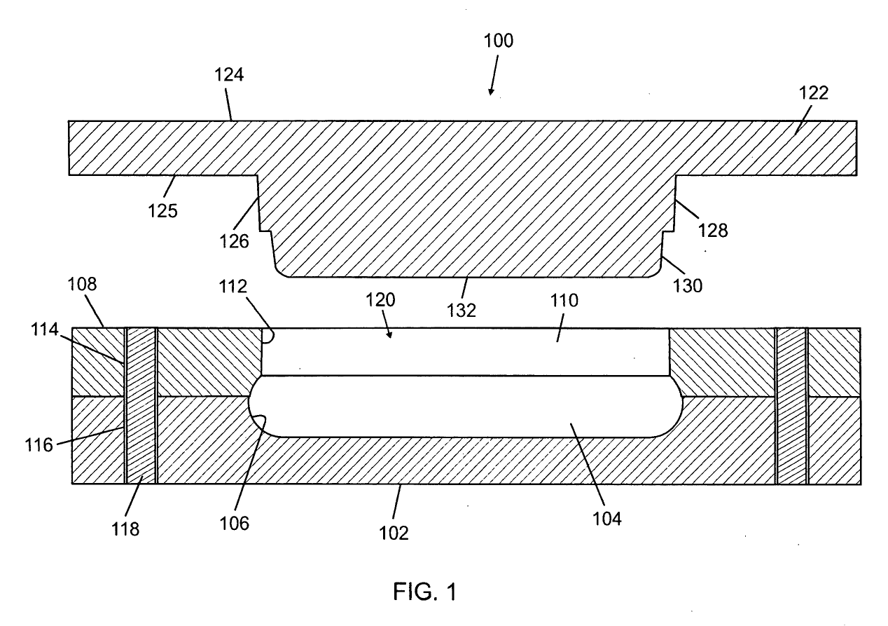

FIG. 1 is a cross-sectional view of an apparatus 100 for making a shaped article. In general, a shaped article will be considered herein as having a top surface with a top surface profile and a bottom surface with a bottom surface profile. The terms “top surface” and “bottom surface” are arbitrary. Each of the top surface and bottom surface may be the inner or outer surface (front or back surface) of the shaped article. The apparatus 100 includes a bottom mold 102. In one example, the bottom mold 102 is in plate form. A cavity 104 is formed in the bottom mold 102. The cavity 104 is defined by a surface 106 having a surface profile which matches at least a portion of the bottom surface profile of the shaped article. The surface 106 is generally concave, as illustrated in FIG. 1. The surface profile of the surface 106 may be smooth or may be more complex, e.g., including convex and/or textured portions (e.g., bumps and/or depressions).

The apparatus 100 further includes an intermediate mold 108. In one example, the intermediate mold 108 may be in a plate form. In one example, the intermediate mold 108 is distinct from the bottom mold 102 and is selectively (or temporarily) stacked on the bottom mold 102 as shown in FIG. 1. The intermediate mold 108 includes a hole 110 defined by a surface 112. The hole 110 is aligned with the cavity 104 in the bottom mold 102 when the intermediate mold 108 is stacked on the bottom mold 102. Surface 112 is generally vertical, and may be straight or slightly slanted inwardly or outwardly to align with the cavity 104. While the intermediate mold 108 is stacked on the bottom mold 102, any suitable mechanism for aligning the hole 110 in the intermediate mold 108 with the cavity 104 in the bottom mold 102 may be used. In one example, the hole 110 in the intermediate mold 108 and the cavity 104 in the bottom mold 102 are aligned by alignment features in the intermediate mold 108 and the cavity 104. In one non-limiting example, the alignment features may be complementary holes 114, 116 in the intermediate mold 108 and cavity 104, respectively, which can receive an alignment pin 118. A plurality of such alignment features 114, 116, 118 may be provided in the intermediate mold 108 and cavity 104.

The hole 110 in the intermediate mold 108 and the cavity 104 in the bottom mold 102, when stacked and aligned as illustrated in FIG. 1, define a continuous mold cavity, generally indicated at 120, for molding the bottom surface of the shaped article. As such, the bottom surface profile of the shaped article may be provided completely by the surface 106 defining the cavity 104 or partially by the surface 106 defining the cavity 104 and partially by the surface 112 defining the hole 110. The latter forms a basis for the previous statement that the surface 106 defining the cavity 104 is defined by a surface profile matching at least a portion of the bottom surface profile of the shaped article.

The apparatus 100 further includes a top mold 124 having a base 122, which may be in the form of a plate, and a protuberance 126 formed on a surface 125 of the base 122. In the illustrated example, the protuberance 126 has a top protuberance portion 128 and a bottom protuberance portion 130. The bottom protuberance portion 130 is defined by a surface 132 having a surface profile matching the top surface profile of the shaped article. The protuberance 126 is sized for insertion into the hole 110 and cavity 104 in the intermediate mold 108 and bottom mold 102, respectively. The top protuberance portion 128 is sized to plug the hole 110 by insertion in the hole 110. In general, the top protuberance portion 128 is larger in size, or diameter, than the bottom protuberance 130 to allow the bottom protuberance portion 130 to pass through the hole 110 in the intermediate mold 108.

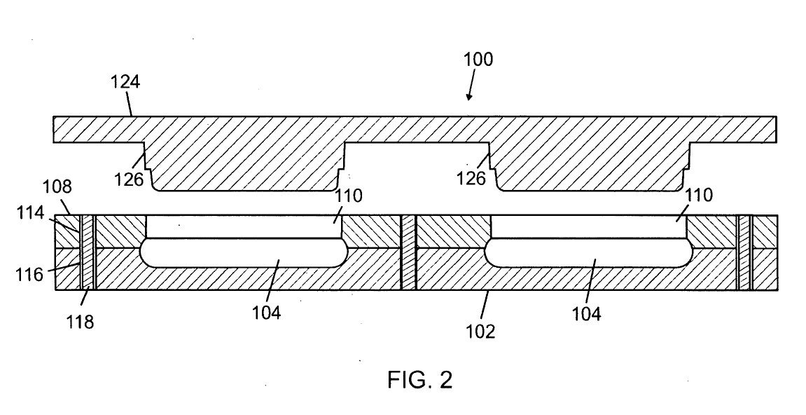

For an apparatus 100 for making a plurality of shaped articles, as illustrated in FIG. 2, the bottom mold 102 includes a plurality of cavities 104 (as described above) spaced apart from each other. The intermediate mold 108 likewise includes a plurality of holes 110 (as described above) spaced apart from each other. The holes 110 and cavities 104 are arranged in the intermediate and bottom molds 108, 102, respectively, such that when the intermediate mold 108 is stacked on the bottom mold 102, each hole 110 in the intermediate mold 108 is aligned with one of the cavities 104 in the bottom mold 102. Alignment features, such as described above, may assist in aligning the holes 110 and cavities 104. The top mold 124 also includes a plurality of protuberances 126 (as described above) for insertion into each aligned hole 110 and cavity 104. Each corresponding set of hole 110, cavity 104, and protuberance 126 may be custom-shaped to form a particular shaped article.

The bottom, intermediate, and top molds 112, 108, 124 may be made of a suitable heat resistant material, i.e., one that would not interact with the material to be used in forming the shaped article(s). Typically, the mold material is selected such that there isn't a large mismatch in coefficient of thermal expansion (CTE) between the mold material and the material of the shaped article(s). In one non-limiting example, the mold material is selected such that the absolute CTE mismatch between the mold material and the material of the shaped article(s) is less than about 1×10⁻⁶/°C. In one non-limiting example, the shaped article is made of a glass-based material, such as a glass or glass-ceramic. For glass-based materials, examples of suitable material for the molds include, but are not limited to, stainless steel and graphite. The surface of the molds including the shaping profiles may be coated with a non-stick material, such as, but not limited to, boron nitride, calcium hydroxide, and carbon soot to facilitate separation of the shaped article from the molds.

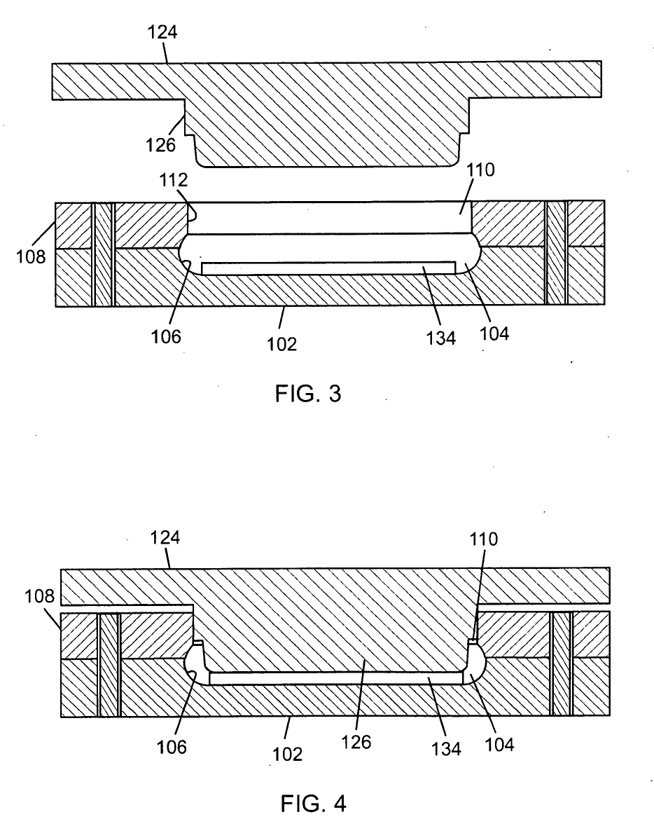

FIGS. 3-5 illustrate a method of making a shaped article. In FIG. 3, the intermediate mold 108 is stacked on the bottom mold 102 such that the hole 110 in the intermediate mold 108 and the cavity 104 in the bottom mold 102 are aligned. Next, a sheet of glass-based material 134 is disposed at the bottom of the cavity 104. At this point, the sheet 134 is a flat piece of glass-based material (as opposed to a preform having a shape that approximates the shape of the shaped article to be formed). The sheet of glass-based material 134 is heated to a temperature above the softening temperature of the glass-based material while being disposed at the bottom of the cavity 104. Typically, heating of the sheet 134 also includes heating of the intermediate and bottom molds 108, 102. The top mold 124 may also be heated. In one example, the sheet 134 is heated to a temperature of about 20° C. higher than the softening point of the glass-based material. In another example, the sheet 134 is heated to a temperature of about 50° C. higher than the softening point of the glass-based material.

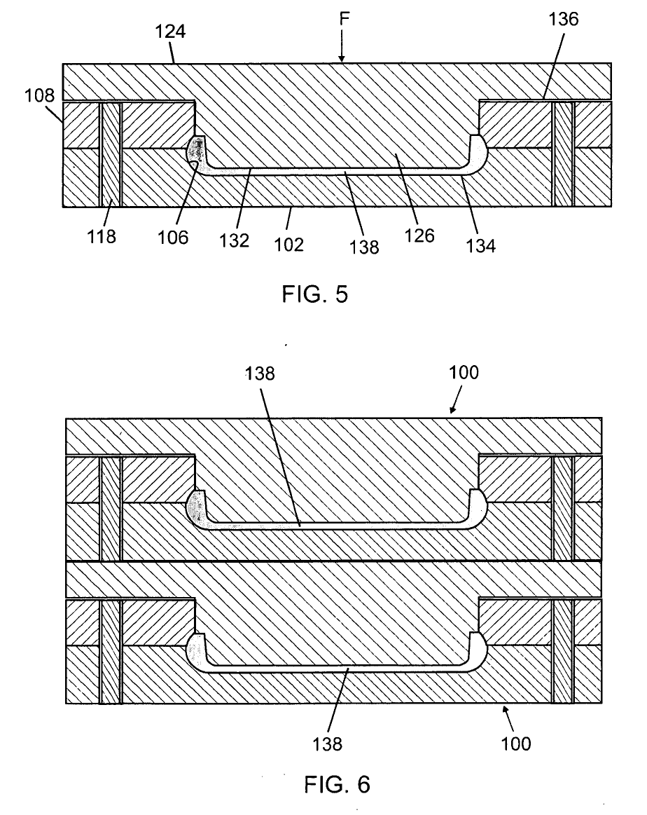

FIG. 3 shows the top mold 124 suspended over the intermediate and bottom molds 108, 102 with the protuberance 126 aligned with the hole 110 and cavity 104 in the intermediate and bottom molds 108, 102, respectively. In FIG. 4, the protuberance 126 is inserted into the aligned hole 110 and cavity 104 and brought into contact with the sheet 134. In FIG. 5, a load F is applied to the sheet 134 through the protuberance 126. The applied load compresses the sheet 134 between the surface 132 of the protuberance 126 and the surface 106 of the cavity 104 so that the sheet 134 deforms and fills the space between the protuberance 126 and the cavity 104. The surface of the sheet 134 in contact with the protuberance 126 takes on the top surface profile carried by the protuberance 126, while the surface of the sheet 134 in contact with the cavity 104 takes on the bottom surface profile carried by the cavity 134. Where the sheet 134 is also squeezed into the hole 110, the sheet 134 also takes on the bottom surface profile carried by the hole 110. The protuberance 126 plugs the hole 110 by insertion, thereby preventing the sheet 134 from being squeezed out of the hole 110.

The amount of force applied to the sheet 134 through the protuberance 126 in FIG. 5 should be sufficient to compress the sheet 134 between the protuberance 126 and cavity 104 and may be based on the desired thinness of the final shaped article. In general, shaped articles having walls with thickness below about 2 mm can be formed by this method. Shaped articles with thicker walls may also be formed by this method. In one non-limiting example, a force of 100 to 500 N may be applied to the sheet 134 for a few seconds to a few minutes to achieve the desired compression of the sheet 134. It should be noted that the force applied to the sheet 134 may come from the sheer weight of the top mold 124. Additional load may be applied to the top mold 124 as necessary to achieve the desired force to compress the sheet 134. In FIG. 5, a gap 136 is present between the opposing surfaces of the top mold 124 and the intermediate mold 110 at the completion of pressing of the sheet 134 (i.e., when the space between the protuberance 126, the hole 110 and cavity 104 is filled by the sheet 134). The gap 136 facilitates subsequent separation of the top mold 124 from the intermediate and bottom molds 110,102.

The pressed sheet 134 in FIG. 5 is the desired shaped article 138. The shaped article 138 is allowed to cool between the molds 124, 110, 102. The shaped article 138 may be allowed to cool to a temperature below the strain point of the glass-based material from which the shaped article is formed. For example, the shaped article may be cooled to a temperature of about 50° C. below the glass strain point. Then, the top mold 124 is separated from the intermediate and bottom molds 110, 102. Next, the intermediate mold 110 is separated from the bottom mold 102, for example, by removing the alignment pins 118, to liberate the shaped article 138. Additional processing of the shaped article 138 may include annealing the shaped article 138 and chemically strengthening the shaped article 138. The shaped article may also be finished, e.g., by fire polishing, to improve its surface quality. The method described herein can be used to form a plurality of discrete shaped articles 138. Further, a stack of apparatus 100 as explained above can be used to make several discrete shaped articles 138 in a single operation or step (see FIG. 6).

In one example, the sheet 134 used in making the shaped article is made of a glass-based material that can be chemically strengthened by ion-exchange. Typically, the presence of small alkali metal ions such as Li⁺ and Na⁺ in the glass structure that can be exchanged for larger alkali metal ions such as K⁺ render the glass composition suitable for chemical strengthening by ion-exchange. The base glass composition can be variable. For example, U.S. patent application Ser. No. 11/888,213, assigned to the instant assignee, discloses alkali-aluminosilicate glasses that are capable of being strengthened by ion-exchange and down-drawn into sheets. The glasses have a melting temperature of less than about 1650° C. and a liquidus viscosity of at least about 1.3×10⁵ Poise and, in one embodiment, greater than about 2.5×10⁵ Poise. The glasses can be ion-exchanged at relatively low temperatures and to a depth of at least 30 μm. Compositionally the glass comprises: 64 mol %≦SiO₂≦68 mol %; 12 mol %≦Na₂O≦16 mol %; 8 mol %≦Al₂O₃≦12 mol %; 0 mol %≦B₂O₃≦3 mol %; 2 mol %≦K₂O≦5 mol %; 4 mol %≦MgO≦6 mol %; and 0 mol %≦CaO≦5 mol %, wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)—Al₂O₃≦2 mol %; 2 mol %≦Na₂O—Al₂O₃≦6 mol %; and 4 mol %≦(Na₂O+K₂O)—Al₂O₃≦10 mol %.

The ion-exchange process typically occurs at an elevated temperature range that does not exceed the transition temperature of the glass. The glass is dipped into a molten bath comprising a salt of an alkali metal, the alkali metal having an ionic radius that is larger than that of the alkali metal ions contained in the glass. The smaller alkali metal ions in the glass are exchanged for the larger alkali metal ions. For example, a glass sheet containing sodium ions may be immersed in a bath of molten potassium nitrate (KNO₃). The larger potassium ions present in the molten bath will replace smaller sodium ions in the glass. The presence of the large potassium ions at sites formerly occupied by sodium ions creates a compressive stress at or near the surface of the glass. The glass is then cooled following ion exchange. The depth of the ion-exchange in the glass is controlled by the glass composition. For potassium/sodium ion-exchange process, for example, the elevated temperature at which the ion-exchange occurs can be in a range from about 390° C. to about 430° C., and the time period for which the sodium-based glass is dipped in a molten bath comprising a salt of potassium can range from about 7 up to about 12 hours (with less time being required at higher temperatures, and more time being required at lower temperatures). In general, the deeper the ion-exchange, the higher the surface compression and the stronger the glass can be.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus for forming a shaped article having a first surface with a first surface profile and a second surface with a second surface profile, the apparatus comprising:
a first end mold having a cavity formed therein, said cavity being defined by a surface having at least a portion of the first surface profile;
an intermediate mold having a hole formed therein, said intermediate mold being distinct from the first end mold and being configured for stacking against the first end mold such that the hole is aligned with the cavity; and
a second end mold having a protuberance formed on a surface thereof, said protuberance being defined by a surface having at least a portion of the second surface profile and being sized for insertion into the hole and cavity.

2. The apparatus of claim 1, wherein the protuberance comprises a first portion sized for insertion into the cavity and a second portion sized for insertion into the hole.

3. The apparatus of claim 2, wherein the first portion is defined by the surface having at least a portion of the second surface profile.

4. The apparatus of claim 2, wherein the second portion is sized to plug the hole by insertion in the hole.

5. The apparatus of claim 1, further comprising complementary alignment features located on the first end mold and intermediate mold.

6. An apparatus for forming a plurality of shaped articles, each shaped article having a first surface with a first surface profile and a second surface with a second surface profile, the apparatus comprising:
a first end mold having a plurality of cavities formed therein, each of said cavities being defined by a surface having at least a portion of the first surface profile;
an intermediate mold having a plurality of holes formed therein, said intermediate mold being distinct from the first end mold and being configured for stacking against the first end mold such that each of the holes is aligned with one of the cavities; and
a second end mold having a plurality of protuberances formed on a surface thereof, each of said protuberances being defined by a surface having at least a portion of the second surface profile and being sized for insertion into one of the holes and one of the cavities.

7. The apparatus of claim 6, wherein each of the protuberances comprises a first portion sized for insertion into one of the cavities and a second portion sized for insertion into one of the holes, and wherein the first portion is defined by the surface having the at least a portion of the second surface profile.

8. The apparatus of claim 7, wherein each of the second portions is sized to plug one of the holes by insertion in one of the holes.

9. The apparatus of claim 6, further comprising complementary alignment features located on the first end mold and intermediate mold.

10. A method of making a shaped article having a first surface with a first surface profile and a second surface with a second surface profile, the method comprising:
aligning a cavity in a first end mold with a protuberance in a second end mold, the cavity being defined by a surface having at least a portion of the first surface profile, the protuberance being defined by a surface having at least a portion of the second surface profile;
placing a sheet of glass-based material at a bottom of the cavity;
compressing the sheet between the surface having at least a portion of the first surface profile and the surface having at least a portion of the second surface profile to impress said at least a portion of the first surface profile and said at least a portion of the second surface profile on a first surface and a second surface, respectively, of the sheet, thereby forming a shaped article.

11. The method of claim 10, further comprising heating the sheet to a temperature above a softening temperature of the glass-based material prior to compressing the sheet between the protuberance and the cavity.

12. The method of claim 11, wherein compressing the sheet comprises applying a load to the sheet through the protuberance.

13. The method of claim 11, further comprising cooling the shaped article to a temperature below the strain point of the glass-based material after compressing the sheet between the protuberance and the cavity.

14. The method of claim 13, further comprising removing the shaped article from between the protuberance and the cavity.

15. The method of claim 14, wherein compressing the sheet comprises inserting the protuberance into the cavity.

16. The method of claim 15, wherein inserting the protuberance into the cavity comprises inserting the protuberance through a hole formed in an intermediate mold stacked on the first end mold.

17. The method of claim 16, wherein removing the shaped article comprises separating the intermediate mold from the first end mold.

18. The method of claim 14, further comprising annealing the shaped article.

19. The method of claim 18, further comprising chemically strengthening the shaped article.
